(19) United States
(12) Patent Application Publication
(10) Pub. No.: US 2015/0186686 A1
(43) Pub. Date: Jul. 2, 2015

(54) READER AND INFORMATION PROCESSING SYSTEM EMPLOYING SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: ZONG-YUAN SUN, New Taipei (TW); DA-HUA XIAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/574,759

(22) Filed: Dec. 18, 2014

(30) Foreign Application Priority Data
Dec. 30, 2013 (CN) 201310742256.5

(51) Int. Cl. G06K 7/00; G06K 7/10

(52) U.S. Cl. CPC G06K 7/0004; G06K 7/10198; G06K 7/10881

(57) ABSTRACT

A reader includes a button, a reading module, a processor, and a communication module. The button module inputs and edits information. The reading module reads information from radio frequency identification tags or bar cores on products. The processor processes read information and input information. The communication module transmits the read information and the input information to a portable electronic device. An information processing system employing the reader is also provided.

### FIELD

The subject matter herein generally relates to a reader, and particularly relates to a reader and an information processing system employing the reader.

### BACKGROUND

Portable terminals including a reader are widely used in shipping for reading tag information on products.

### BRIEF DESCRIPTION OF THE DRAWINGS

Implementations of the present technology will now be described, by way of example only, with reference to the attached figures.

FIG. 1 is an isometric view of an exemplary embodiment of a reader.

FIG. 2 is another isometric view of the reader of FIG. 1.

FIG. 3 is a block diagram of an exemplary embodiment of an information processing system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

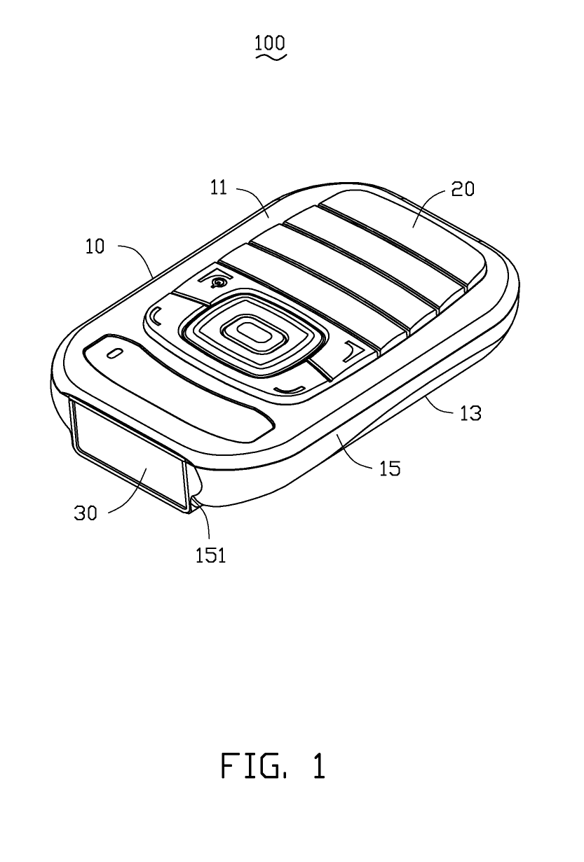

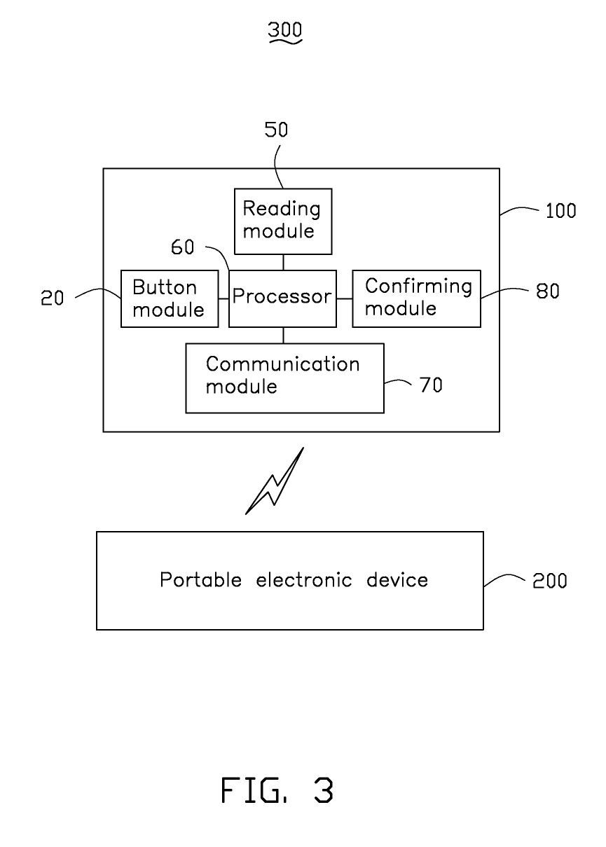

FIGS. 1 and 3 illustrate at least one embodiment of an information processing system 300 including a reader 100 and a portable electronic device 200. The reader 100 is applied for reading and editing radio frequency identification (RFID) tags or bar code on products in the shipping industry. The portable electronic device 200 can be a smart phone, a personal digital assistant (PDA) or a tablet computer.

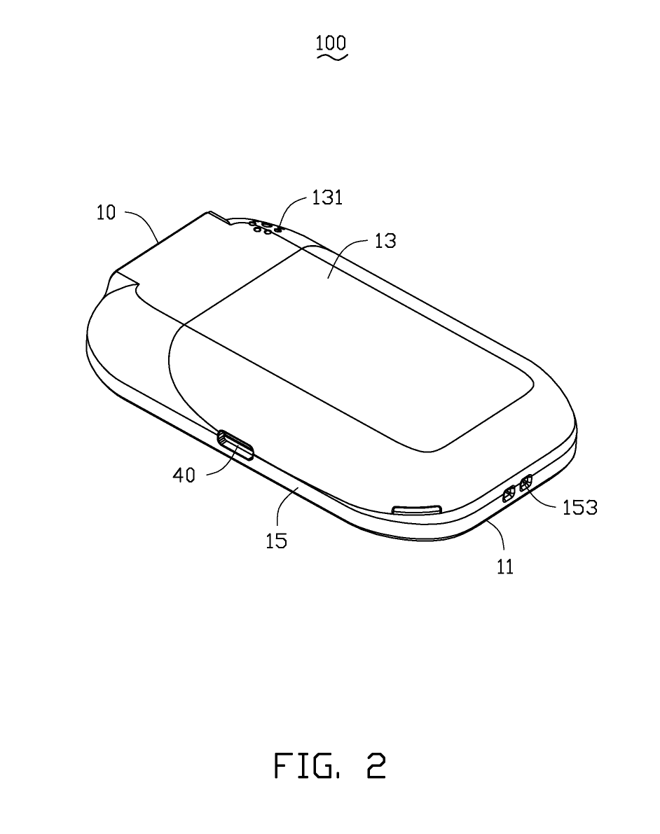

FIGS. 1 and 2 illustrate that the reader 100 includes a body 10, a button module 20, a panel 30, and a power connector 40. The button module 20, the panel 30, and the power connector 40 are mounted on the body 10.

The body 10 is substantially rectangular in shape and includes a top wall 11, an opposite bottom wall 13, and four side walls 15 connecting the top wall 11 and the bottom wall 13. The bottom wall 13 defines a plurality of sound holes 131 for transmitting sound, such as a buzzer. One of the side walls 15 defines an opening 151. One of the side walls 15 opposite to the opening 151 defines ornament holes 153 for coupling ornaments.

The button module 20 is arranged on the top wall 11 and configured to input information, such as shipper information, consignee information and contact information. In at least one embodiment, the button module 20 includes a power button, a switch button, a plurality of number buttons, and other buttons.

The power connector 40 is defined on one of the side walls 15 and configured to charge the reader 100.

FIG. 3 illustrates that the reader 100 can further include a reading module 50, a processor 60, a communication module 70, and a confirming module 80. The button module 20, the reading module 50, the communication module 70, and the confirming module 80 are electrically connected to the processor 60. The reading module 50 is received in the body 10 via the opening 151. The panel 30 covers the opening 151 to protect the reading module 50. In at least one embodiment, the panel 30 can be made of transparent organic glass; thereby the reading module 50 can read the information from the RFID tags and bar cores via the panel 30.

The reading module 50 is configured to read information, a shipment sequence number for example, from the RFID tags and bar core of the products. In at least one embodiment, the reading module 50 can be a high frequency reading module, an ultrahigh frequency reading module, or a 2.4 G active reading module. Users can select corresponding reading modules according to different RFID tags and bar codes.

The processor 60 processes the information input by the button module 20 and the information read by the reading module 50, and transmits the processed information to the communication module 70. In at least one embodiment, the communication module 70 can be a BLUETOOTH® module or a wireless fidelity (WI-FI) module, which can establish communication with the portable electronic device 200 and transmit the processed information to the portable electronic device 200.

The confirming module 80 is configured to confirm whether the reading module 50 has successfully read the information. In at least one embodiment, the when the processor 60 successfully receives information from the reading module 50, the processor 60 controls the confirming module 80 to inform the user that the processor 60 has successfully read the information. When the processor 60 does not receive information from the reading module 50, the confirming module 80 does not inform the user that the processor 60 has unsuccessfully read information. In at least one embodiment, the confirming module 80 can be a buzzer or a lamp.

The portable electronic device 200 is configured to receive the processed information from the reader 100 and displaying the information of the button module 20 and the reading module 50. The portable electronic device 200 further transmits the information of the button module 20 and the reading module 50 to servers of the shipping network located nearby via wireless communication network.

The information processing system 300 can operate as follows: the reader 100 establishes communication with the portable electronic device 200. The reading module 50 reads information from the RFID tag or the bar cores of products via the panel 30, and transmits the information to the processor 60. When the processor 60 successfully receives the information, the confirming module 80 is controlled to give notice that information has been successfully read; meanwhile the processor 60 controls the reading module 50 to stop reading the information. Synchronously, the user can input and edit information via the button module 20, and transmit the information to the processor 60. The processor 60 processes the read information and the input information and transmits the processed information to the communication module 70. The communication module 70 transmits the processed information to the portable electronic device 200. The portable electronic device 200 can display the read information and the input information. The portable electronic device 200 further transmits the information to nearby servers of the shipping network.

The reader 100 and the portable electronic device 200 can be separate units, the reader 100 is configured to read and input information, and the portable electronic device 200 is configured to display the information and transmit the information to servers nearby. In addition, the reader 100 can edit the information via the button module 20. Therefore, a display module and a transmission module of the reader 100 can be omitted, such that the size of the reader 100 can be decreased, and manufacturing cost of the reader 100 can be decreased.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A reader comprising:
a button module configured to input and edit information;
a reading module configured to read information from radio frequency identification (RFID) tags or bar cores on products;
a processor configured to process read information by the reading module and input information by the button module; and
a communication module configured to transmit the read information and the input information to a portable electronic device.

2. The reader as claimed in claim 1, further comprising a body, wherein the button module, the reading module, the processor, and the communication module are mounted in the body.

3. The reader as claimed in claim 2, wherein the body comprises a top wall, a bottom wall opposite to the top wall, and four side walls connecting the top wall and the bottom wall;
the button module is mounted to the top wall, the bottom wall defines a plurality of sound holes for transmitting sound from internal of the reader to external.

4. The reader as claimed in claim 3, further comprising a panel and power connector, wherein one of the side walls defines an opening, the panel is mounted in the opening; one another of the side walls defines ornament holes configured to couple ornament components; the power connector is arranged in one another of the side walls.

5. The reader as claimed in claim 4, wherein the reading module is received in the body via the opening, the panel covers the opening to protect the reading module, the reading module read the information from the RFID tags and bar cores via the panel.

6. The reader as claimed in claim 1, wherein the button module comprises a power button, a switch button, or a plurality of number buttons.

7. The reader as claimed in claim 1, further comprising a confirming module, wherein when the processor successfully receives the information from the reading module, the processor controls the confirming module to work, and wherein when the processor unsuccessfully receives the information, the processor controls the confirming module not to work.

8. The reader as claimed in claim 7, wherein the confirming module is a buzzer or a lamp.

9. The reader as claimed in claim 1, wherein the communication module is a BLUETOOTH module or a wireless fidelity (WI-FI) module.

10. An information processing system comprising:
a portable electronic device; and
a reader communicating with the portable electronic device, the reader comprising:
a button module configured to input and edit information;
a reading module configured to read information from radio frequency identification (RFID) tags or bar cores on products;
a processor configured to process read information by the reading module and input information by the button module; and
a communication module configured to transmit the read information and the input information to the portable electronic device.

11. The information processing system as claimed in claim 10, further comprising a body, wherein the button module, the reading module, the processor, and the communication module are mounted in the body.

12. The information processing system as claimed in claim 11, wherein the body comprises a top wall, a bottom wall opposite to the top wall, and four side walls connecting the top wall and the bottom wall, and wherein the button module is mounted to the top wall, the bottom wall defines a plurality of sound holes for transmitting sound from internal of the reader to external.

13. The information processing system as claimed in claim 12, further comprising a panel and power connector, wherein one of the side walls defines an opening, the panel is mounted in the opening; one another of the side walls defines ornament holes configured to couple ornament components; the power connector is arranged in one another of the side walls.

14. The information processing system as claimed in claim 13, wherein the reading module is received in the body via the opening, the panel covers the opening to protect the reading module, the reading module read the information from the RFID tags and bar cores via the panel.

15. The information processing system as claimed in claim 10, wherein the button module comprises a power button, a switch button, or a plurality of number buttons.

16. The information processing system as claimed in claim 10, further comprising a confirming module, wherein when the processor successfully receives the information from the reading module, the processor controls the confirming module to work, and wherein when the processor unsuccessfully receives the information, the processor controls the confirming module not to work.

17. The information processing system as claimed in claim 16, wherein the confirming module is a buzzer or a lamp.

18. The information processing system as claimed in claim 10, wherein the communication module is a BLUETOOTH module or a wireless fidelity (WI-FI) module.

19. The information processing system as claimed in claim 10, wherein the portable electronic device is configured to display the read information and the input information.

20. The information processing system as claimed in claim 19, wherein the portable electronic device further transmits the read information and the input information to nearby servers of the express or delivery network.
